(19) United States
(12) Patent Application Publication
(10) Pub. No.: US 2019/0054725 A1
(43) Pub. Date: Feb. 21, 2019

(54) INLINE LAMINATION AND COATING OF A CELLULOSE BASED SUBSTRATE

(71) Applicant: Midwest Recycled & Coated Containerboard Mill, LLC, Combined Locks, WI (US)

(72) Inventors: Douglas OSTERBERG, Menasha, WI (US); Mark GOCKER, Kaukauna, WI (US); April VAN CAMP, Freedom, WI (US); William CASEY, Appleton, WI (US)

(21) Appl. No.: 16/102,530

(22) Filed: Aug. 13, 2018

Related U.S. Application Data
(60) Provisional application No. 62/546,224, filed on Aug. 16, 2017.

(51) Int. Cl. B32B 37/00; B32B 37/12; B32B 38/00; B32B 9/06; B05C 1/12; B05C 1/08

(52) U.S. Cl. CPC B32B 37/0053; B32B 37/0038; B32B 37/1284; B32B 38/164; B32B 9/06; B05C 1/12; B32B 2255/12; B05C 1/0834; B32B 2037/1276; B32B 2255/205; B32B 2255/26; B32B 2255/28; B32B 2307/4026; B05C 1/0821

(57) ABSTRACT

A coater configured to manufacture a laminated coated product. The coater includes a first coating station configured to apply an adhesive to a side of a first cellulose based substrate, a first nip assembly configured to press the adhesive coated side of the first cellulose based substrate to a second cellulose based substrate to form a laminate, a first dryer section configured to dry the adhesive in the laminate, a second coating station configured to apply a coating to the second cellulose based substrate side of the laminate, a second dryer section configured to dry the coating on the laminate, and a reel section configured to wind a reel of the laminate.

### FIELD OF THE INVENTION

The present disclosure relates to producing a laminated product formed of a plurality of cellulose based substrates. More specifically, the disclosure relates to a system for inline lamination and coating of two dry cellulose based substrates with a blade coater.

### BACKGROUND

Lamination is generally known in the art. Lamination is a technique of manufacturing a material in multiple layers to form a composite material, or a laminate. A laminate of a plurality of porous substrates, such as a plurality of cellulose based substrates like paper, is generally produced on a paper machine. For example, a cylinder paper machine includes a plurality of cylinders arranged in series along a single pick-up felt. Each cylinder is a hollow vacuum roll covered with a wire screen that rotates in a separate tub of stock, which is diluted pulp mixed with other paper making additives. Each cylinder uses the vacuum to collect a mat of fibers from the associated tub, and then deposits the mat onto the pick-up felt. As the pick-up felt contacts each cylinder in series, multiple layers of stock are deposited on the pick-up felt. The multiple layers of stock are then dewatered (e.g., by one or more vacuum boxes, a press section, a dryer section, etc.) to form a laminate.

Producing a laminate on a paper machine has certain limitations. For example, a cylinder machine is a customized paper machine for manufacturing cellulose laminate. Manufacturers having other types of paper machines, such as those having a wet end with a single head box (e.g., a fourdrinier, a gap former, etc.) can only introduce a single layer of stock to a forming wire. Thus, a laminated sheet cannot be produced on these paper machines without a substantial capital investment of at least an additional head box and supporting stock supply components.

Accordingly, there is a need for manufacturers to be able to produce a laminate formed of a plurality of cellulose based substrates without a substantial capital investment to a paper machine. There is also a need to be able to produce a laminate using certain existing equipment found in a paper manufacturing facility (i.e., a paper mill).

### SUMMARY

The invention provides, in one aspect, a coater configured to manufacture a laminated coated product. The coater includes a first coating station configured to apply an adhesive to a side of a first cellulose based substrate, a first nip assembly configured to press the adhesive coated side of the first cellulose based substrate to a second cellulose based substrate to form a laminate, a first dryer section configured to dry the adhesive in the laminate, a second coating station configured to apply a pigment based coating to the second cellulose based substrate side of the laminate, a second dryer section configured to dry the pigment based coating on the laminate, and a reel section configured to wind a reel of the laminate.

The invention provides, in another aspect, a coater that includes a first coating station, a nip assembly, a second coating station, a third coating station, a first unwind stand, and a second unwind stand. In a first coating configuration, a bleached cellulose based substrate travels from the first unwind stand to the first coating station, from the first coating station to the second coating station, and from the second coating station to the first reel section, wherein a pigment based coating is applied to a first side of the bleached cellulose based substrate at the first coating station, and a pigment based coating is applied to a second side of the bleached cellulose based substrate at the second coating station. In a second inline laminating and coating configuration, a bleached cellulose based substrate travels from the first unwind stand to the nip assembly, an unbleached cellulose based substrate travels from the second unwind stand to the second coating station and then to the nip assembly, wherein an adhesive is applied to a side of the unbleached cellulose based substrate at the second coating station, the bleached cellulose based substrate contacts the adhesive side of the unbleached cellulose based substrate at the nip assembly to form a laminate, the laminate travels to the third coating station, wherein a pigment based coating is applied to the bleached cellulose based substrate side of the laminate to form a coated laminate.

Other features and aspects of the invention will become apparent by consideration of the following detailed description and accompanying drawings.

### BRIEF DESCRIPTION OF THE DRAWINGS

FIG. 1 is a schematic diagram of an embodiment of a coater.

FIG. 2 is a schematic diagram of the coater of FIG. 1 operating in a first operational configuration to apply one layer of pigment based coating on each side of a cellulose based substrate.

FIG. 3 is a schematic diagram of the coater of FIG. 1 operating in a second operational configuration to apply one layer of pigment based coating on each side of a cellulose based substrate.

FIG. 4 is a schematic diagram of the coater of FIG. 1 operating in a third operational configuration to apply two layers of pigment based coating on each side of a cellulose based substrate.

FIG. 5 is a schematic diagram of the coater of FIG. 1 operating in a fourth operation configuration to inline laminate two cellulose based substrates and apply a pigment based coating on at least one side of the resultant laminate.

FIGS. 6A-6B are consecutive side views of the coater illustrated by the schematic in FIG. 2, with element A of FIGS. 6A and 6B being a common element.

FIGS. 7A-7C are consecutive side views of the coater illustrated by the schematic in FIG. 3, with element A of FIGS. 7A and 7B being a common element, and element B of FIGS. 7B and 7C being a common element.

FIGS. 8A-8D are consecutive side views of the coater illustrated by the schematic in FIG. 4, with element A of FIGS. 8A and 8B being a common element, element B of FIGS. 8B and 8C being a common element, and element C of FIGS. 8C and 8D being a common element.

FIGS. 9A-9C are consecutive side views of the coater illustrated by the schematic in FIG. 5, with element A of FIGS. 9A and 9B being a common element, and element B of FIGS. 9B and 9C being a common element.

Before any embodiments of the present invention are explained in detail, it should be understood that the invention is not limited in its application to the details or construction and the arrangement of components as set forth in the following description or as illustrated in the drawings. The invention is capable of other embodiments and of being practiced or of being carried out in various ways. It should be understood that the description of specific embodiments is not intended to limit the disclosure from covering all modifications, equivalents and alternatives falling within the spirit and scope of the disclosure. Also, it is to be understood that the phraseology and terminology used herein is for the purpose of description and should not be regarded as limiting.

### DETAILED DESCRIPTION

The invention illustrated in the Figures and disclosed herein is generally directed to an embodiment of a coater 10, and more specifically an off-machine coater 10, that is configured to operate in multiple configurations. In a first operational configuration, the coater 10 is configured to apply a pigment based coating on opposing sides of a cellulose based substrate. In a second operational configuration, the coater 10 is configured to laminate two cellulose based substrates to form a laminate, and apply a pigment based coating on at least one side of the laminate. The coater 10 laminates the two substrates in a dry-web form by an adhesive. The adhesive is applied by a coating head of the coater 10. This advantageously eliminates the need for a specialty paper machine (e.g., a paper machine having multiple head boxes, a cylinder paper machine having multiple cylinders, etc.) to manufacture a cellulose based laminate. In addition, the coater 10 advantageously laminates and coats the laminate inline, eliminating the need for any additional specialty equipment (e.g., a laminator, etc.) to manufacture a cellulose based laminate. Further, the coater 10 can readily switch between the first and second operational configurations, allowing the coater 10 to both apply a pigment based coating to a cellulose based substrate, or laminate a plurality of cellulose based substrates and subsequently apply a pigment based coating to the laminate. This advantageously increases equipment usage, which minimizes equipment downtime. In addition, the coater 10 can advantageously produce a wider variety of cellulose based products (e.g., coated free sheet and coated laminate, etc.).

For ease of discussion and understanding, the following detailed description will refer to a “cellulose based substrate” in association with the coater 10. It should be appreciated that a cellulose based substrate is a substrate that includes cellulose fiber, such as paper. The substrate can also include other additives, such as fillers (e.g., clay, etc.), bonding agents (e.g., retention aids, latex, etc.), and any other material generally introduced during the manufacture of paper. While paper is a cellulose based substrate, the term cellulose based substrate includes other materials that include cellulose fiber or cellulose based fiber material.

It should also be appreciated that the term “cellulose based laminate” is directed to a laminate having at least two layers, with at least two layers being formed of a cellulose based substrate. While the detailed description discusses a cellulose based laminate as having two layers, this is for purposes of example only. The process disclosed herein is not limited to producing a cellulose based laminate having only two layers. Accordingly, the term “cellulose based laminate” can include a laminate formed of a plurality of layers of cellulose based substrate. The layers can be formed of the same (or substantially similar) cellulose based substrates, or different cellulose based substrates. In addition, the cellulose based laminate can include one or more additional layers of non-cellulose based substrate (e.g., plastic, foil, etc.).

In addition, the terms “coater” and “blade coater” are generally directed to equipment that applies a coating to a cellulose based substrate and/or a cellulose based laminate. While the illustrated embodiment of a coater 10 includes a plurality of coating stations, each coating station being a blade coater, in other embodiments each coating station can be any suitable coating applicator. For example, each coating applicator can be a blade coater, a roll coater, an air knife coater, or any other suitable applicator of a pigment based coating to a cellulose based substrate.

The term “off-machine coater” is directed to equipment configured to apply a pigment based coating to a cellulose based substrate that is separate and distinct from a paper machine. Stated another way, the coater does not receive a continuous web of a cellulose based substrate from the paper machine. Instead, the coater receives the cellulose based substrate in a reel (or parent reel) form. Generally, a reel is in excess of two tons, and more specifically in excess often tons, as compared to a processed roll, which is less than two tons. In addition, a reel has a width that is one-half the width, up to and including the entire width, of the paper machine. A reel is also later processed into a plurality of rolls at a winder. As such, a reel has substantially more lineal footage, a larger width, and a greater weight than a roll.

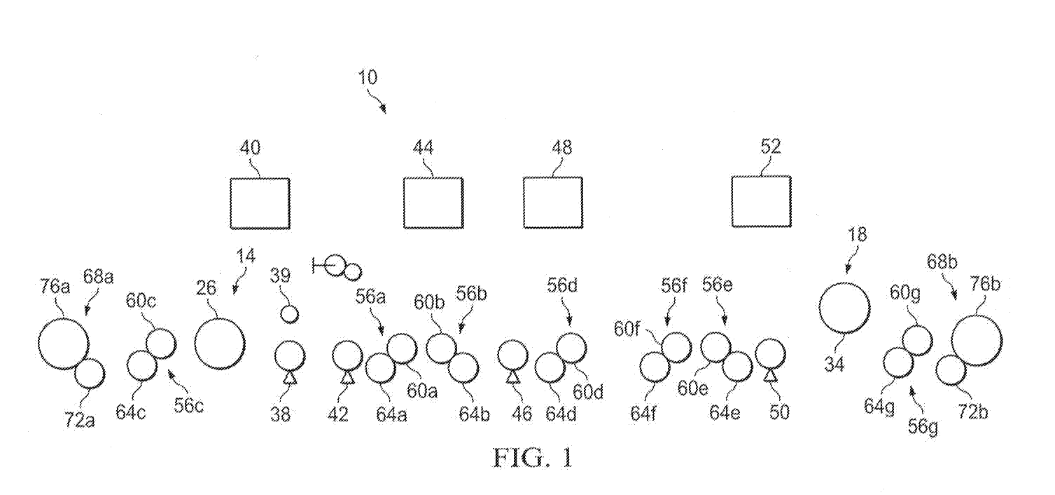

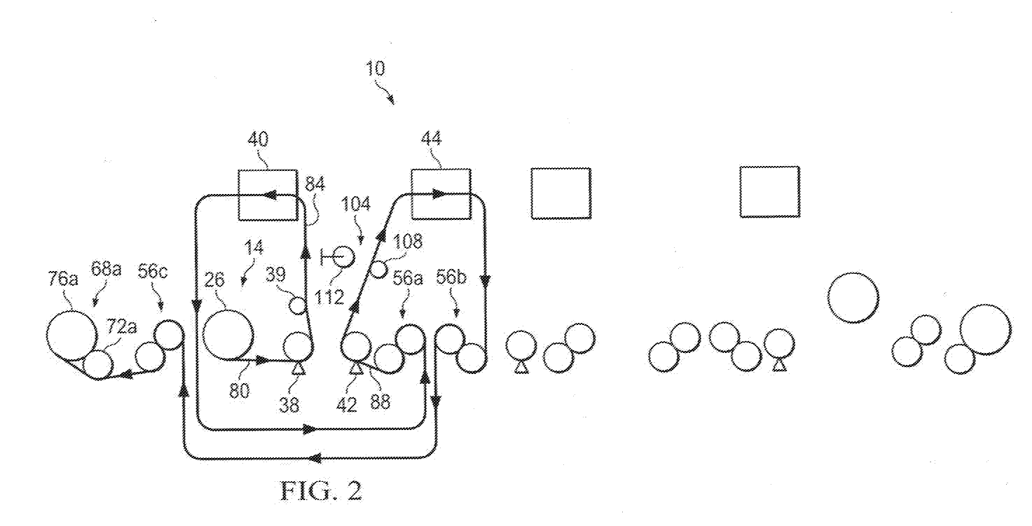

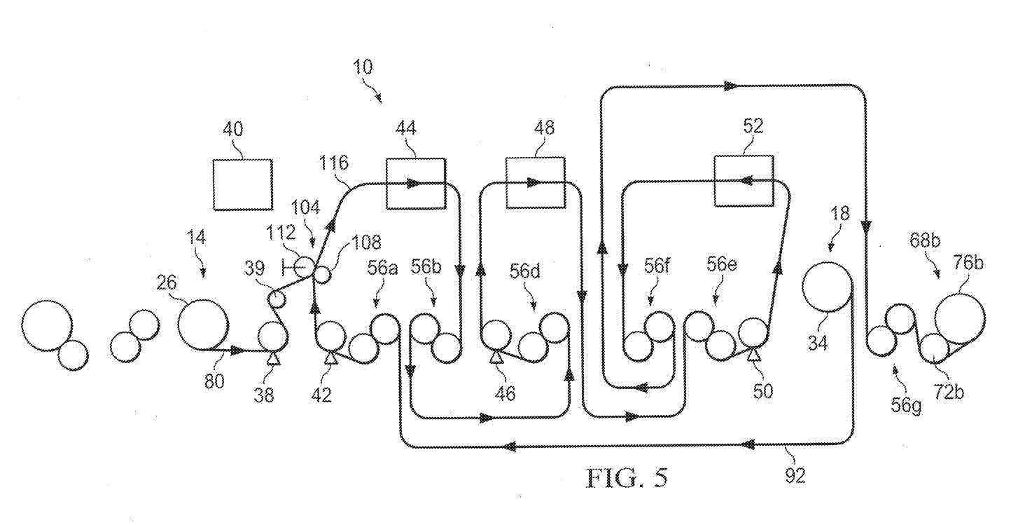

Referring now to the Figures, FIGS. 1-5 illustrate a schematic of the coater 10. FIG. 1 illustrates certain components of the coater 10. FIGS. 2-4 illustrate three different coating configurations of the coater 10 for the application of a pigment based coating to a cellulose based substrate, while FIG. 5 illustrates an inline lamination and coating configuration of the coater 10. Although the examples illustrate the application of a pigment based coating, it is to be understood that any coating may be applied to the substrates as desired. As such, this disclosure explicitly contemplates the use of other types of coatings other than the pigment based coating described in the examples. These alternative coatings may be used with any of the examples as described herein. Examples of these alternative coatings include, but are not limited to, aqueous-based coatings, pigmented coatings, calcium carbonate coatings, clay coatings, titanium dioxide coatings, latex coatings, starch coatings, polyvinyl acetate coatings, polyvinyl alcohol coatings, carboxymethyl cellulose coatings, hydroxymethyl cellulose coatings, epoxy coatings, coatings that are partially or totally impermeable to water, oil, or grease; coatings that may be printed on; improved printability coatings (e.g., better ink absorption into coating than into substrate); inkjet print receptivity (e.g., coatings that improve use in inkjet printers relative to substrate); or barrier coatings to prevent interaction between the base substrate and materials such as food products that may otherwise interact with it; or any combination thereof.

Referring specifically to FIG. 1, the coater 10 includes a first unwind stand 14 and a second unwind stand 18. The first unwind stand 14 is configured to unwind a first reel 26 of a first cellulose based substrate. The second unwind stand 18 is configured to unwind a second reel 34 of a second cellulose based substrate. As such, the coater 10 includes a plurality of unwind stands 14, 18, or at least two unwind stands 14, 18. In other embodiments, the coater 10 can include any suitable number of unwind stands (e.g., three or more, etc.).

The coater 10 also includes a plurality of coating stations. More specifically, the coater 10 includes a first coating station 38, a second coating station 42, a third coating station 46, and a fourth coating station 50. Each coating station 38, 42, 46, 50 is a blade coater, and more specifically a long dwell time applicator (“LDTA”) (or “roll applicator” or “dip roll”) blade coater. In other embodiments each coating station 38, 42, 46, 50 can include any suitable coating applicator (e.g., a short-dwell time applicator (“SDTA”), a curtain coater, a jet-flow coater, a flooded nip, a rod coater, etc.). Each coating station 38, 42, 46, 50 is configured to apply a fluid material to one side of the cellulose based substrate, which is discussed in additional detail below in association with FIGS. 2-5.

The coater 10 also includes a plurality of dryer sections. More specifically, a first dryer section 40 follows the first coating station 38, a second dryer section 44 follows the second coating station 42, a third dryer section 48 follows the third coating station 46, and a fourth dryer section 52 follows the fourth coating station 50. Thus, each coating station 38, 42, 46, 50 has a dryer section that immediately follows the associated coating station 38, 42, 46, 50. Each dryer section 40, 44, 48, 52 is configured to dry the fluid material that is applied to the cellulose based substrate by the associated coating station 38, 42, 46, 50. In the illustrated embodiment, each dryer section 40, 44, 48, 52 includes a plurality of infrared (“IR”) flotation dryers. In other embodiments of the coater 10, each dryer section 40, 44, 48, 52 can include any suitable dryer (e.g., a plurality of hollow dryer cans heated with steam, gas dryers, an air cap, flotation dryers, infrared dryers, air impingement dryers, gas or steam heated cylindrical dryers, etc.). In addition, each dryer section 40, 44, 48, 52 can include any number of dryer sections necessary to dry the fluid material applied to the cellulose based substrate by the associated coating station 38, 42, 46, 50 (e.g., one dryer section, two dryer sections, three or more dryer sections, etc.).

In some embodiments, the dryers may dry the fluid materials through a curing process which may harden and toughen the fluid materials. For example, if the fluid materials comprise a polymeric material, the curing may induce cross-linking of the polymeric material. In some examples, the dryers may comprise components that emit UV radiation and/or apply chemical additives which may induce curing of the fluid materials. Specific examples of these types of dryers may include, but are not limited to, UV, infrared, electron beam, any combination thereof, any combinations of these with the aforementioned drying techniques.

The coater 10 includes a plurality of transport roll sections 56. Each transport roll section 56 includes a plurality of driven rolls 60, 64. For example, a first transport roll section 56a includes at least a first driven roll 60a and a second driven roll 64a. A second transport roll section 56b includes at least a first driven roll 60b and a second driven roll 64b. A third transport roll section 56c includes at least a first driven roll 60c and a second driven roll 64c. A fourth transport roll section 56d includes at least a first driven roll 60d and a second driven roll 64d. A fifth transport roll section 56e includes at least a first driven roll 60e and a second driven roll 64e. A sixth transport roll section 56f includes at least a first driven roll 60f and a second driven roll 64f. While the illustrated embodiment of the coater 10 illustrates six transport roll sections 56, in other embodiments any suitable number of transport roll sections 56 can be employed (e.g., fewer than six, seven or more, etc.). It should also be appreciated that each transport roll section 56 of the coater 10 is a traditional contact dryer section made up of a plurality of hollow drums. However, the drums are not heated (i.e., there is no steam supplied), and as such the drums simply transport the cellulose based substrate. In other embodiments of the coater 10, each transport roll section 56 can be one or more guide rolls, straightening rolls, or other suitable roll to transport and route the cellulose based substrate through the coater 10. It should be appreciated that the coater 10 can include additional guide rolls, straightening rolls, chiller rolls, tension rolls, or other rolls that assist with transporting the cellulose based substrate through the coater 10, but are not illustrated in the schematics of FIGS. 1-5. In addition, though not illustrated, the coater 10 can include one or more scanners to measure aspects of cellulose based substrate during coating (e.g., measure coat weight for control purposes, moisture for control purposes, etc.), or other tools to improve processing performance in the coater 10 (e.g., fogging showers to control curl, etc.).

The coater 10 also includes a plurality of reel sections 68. More specifically, the coater 10 includes a first reel section 68a, and a second reel section 68b. The first reel section 68a includes a king roll 72a. The king roll 72a directs the cellulose based substrate to wind onto a moveable, large diameter core (or reel) to form a coated reel 76a (or parent reel 76a or jumbo reel 76a). The second reel section 68b is substantially the same as the first reel section 68a, and includes a king roll 72b that is configured to direct the cellulose based substrate to wind onto a moveable, large diameter core (or reel) to form a coated reel 76b (or parent reel 76b or jumbo reel 76b). An example of a suitable reel section 68a, 68b includes, but is not limited to, a Pope reel. The coated reels 76a, 76b have a width that generally matches the width of the coater 10.

Referring now to FIG. 2, the coater 10 is illustrated operating in a first operational configuration. In the first operational configuration, the coater 10 is configured to apply one layer of pigment based coating on each side of a first cellulose based substrate 80. The uncoated cellulose based substrate 80 is provided on the first reel 26. The first reel 26 is mounted onto the first unwind 14. The first unwind stand 14 unwinds the first reel 26, directing the uncoated cellulose based substrate 80 to the first coating station 38. At the first coating station 38, a layer of pigment based coating is applied to a first side 84 of the cellulose based substrate 80. After application of the coating, the substrate 80 travels over a drive roll 39 to the first dryer section 40 to dry the coating. The substrate 80 exits the first dryer section 40, where it is routed to the first transport roll section 56a. The first transport roll section 56a is configured to transport the substrate 80 to facilitate application of a coating to a second side 88 of the substrate 80. The substrate 80 exits the first transport roll section 56a and travels to the second coating station 42. At the second coating station 42, a layer of pigment based coating is applied to the second side 88 of the cellulose based substrate 80. After application of the coating, the substrate 80 travels to the second dryer section 44 to dry the coating. The substrate 80 exits the second dryer section 44, where it is routed to the second transport roll section 56b, and then the third transport roll section 56c. The substrate 80 leaves the third transport roll section 56c and enters the first reel section 68a, where the substrate 80 contacts the king roll 72a and is wound to form the coated reel 76a.

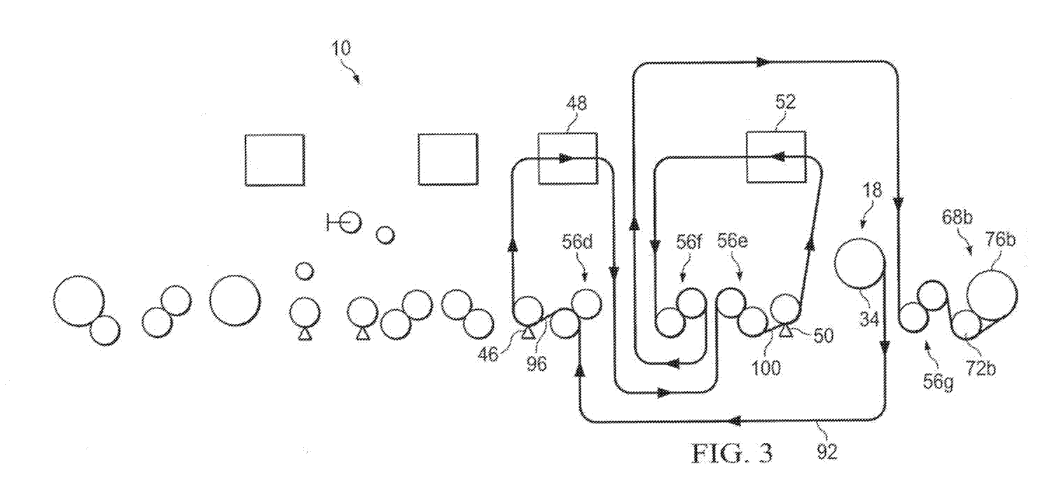

FIG. 3 illustrates the coater 10 operating in a second operational configuration. In the second operational configuration, the coater 10 is configured to apply one layer of pigment based coating on each side of a second cellulose based substrate 92. The uncoated cellulose based substrate 92 is provided on the second reel 34. The second reel 34 is mounted onto the second unwind stand 18 which unwinds the second reel 34, directing the uncoated cellulose based substrate 92 to the fourth transport roll section 56d. The substrate 92 exits the fourth transport roll section 56d and enters the third coating station 46. At the third coating station 46, a layer of pigment based coating is applied to a first side 96 of the cellulose based substrate 92. After application of the coating, the substrate 92 travels to the third dryer section 48 to dry the coating. The substrate 92 exits the third dryer section 48, where it is routed to the fifth transport roll section 56e. The fifth transport roll section 56e is configured to transport and orient the substrate 92 to facilitate application of a coating to a second side 100 of the substrate 92. The substrate 92 exits the fifth transport roll section 56e and travels to the fourth coating station 50. At the fourth coating station 50, a layer of pigment based coating is applied to the second side 100 of the substrate 92. The substrate 92 then travels to the fourth dryer section 52 to dry the coating. The substrate 92 exits the fourth dryer section 52, where it is routed to the sixth transport roll section 56f, and then the seventh transport roll section 56g. The substrate 92 leaves the seventh transport roll section 56g and enters the second reel section 68b, where the substrate 92 contacts the king roll 72b and is wound to form the coated reel 76b.

It should be appreciated that the first and second configuration can operate on the coater 10 separately or concurrently. Stated another way, the coater 10 can operate in the first configuration (shown in FIG. 2), the second configuration (shown in FIG. 3), or with both the first and second configurations operating simultaneously. As such, the first and second configurations can operate on the coater 10 to concurrently coat two reels 26, 34 of uncoated cellulose based substrate 80, 92 with one layer of pigment based coating on each side of the substrate 80, 92.

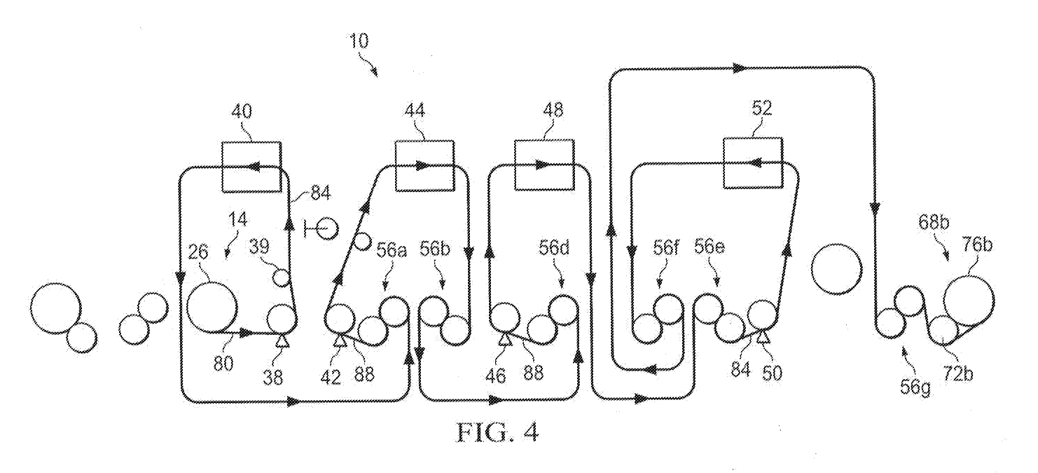

FIG. 4 illustrates the coater 10 operating in a third operational configuration. In the third operational configuration, the coater 10 is configured to apply two layers of pigment based coating on each side of the first cellulose based substrate 80 (referred to as “tandem” coating). The uncoated cellulose based substrate 80 is provided on the first reel 26. The first reel 26 is mounted onto the first unwind stand 14 which unwinds the first reel 26, directing the uncoated cellulose based substrate 80 to the first coating station 38. At the first coating station 38, a first layer of pigment based coating is applied to the first side 84 of the substrate 80. After application of the coating, the substrate 80 travels over the drive roll 39 to the first dryer section 40 to dry the coating. The substrate 80 exits the first dryer section 40, where it is routed to the first transport roll section 56a. The substrate 80 exits the first transport roll section 56a and travels to the second coating station 42. At the second coating station 42, a first layer of pigment based coating is applied to the second side 88 of the cellulose based substrate 80. After application of the coating, the substrate 80 travels to the second dryer section 44 to dry the coating. The substrate 80 exits the second dryer section 44, where it is routed to the second transport roll section 56b, and then the fourth transport roll section 56d. The substrate 80 leaves the fourth transport roll section 56d and enters the third coating station 46, where a second layer of pigment based coating is applied to the second side 88 of the substrate 80. The substrate 80 exits the third coating station 46 and travels to the third dryer section 48 to dry the coating. The substrate 80 exits the third dryer section 48, where it is routed to the fifth transport roll section 56e. The substrate 80 exits the fifth transport roll section 56e and travels to the fourth coating station 50. At the fourth coating station 50, a second layer of pigment based coating is applied to the first side 84 of the substrate 80. The substrate 80 then travels to the fourth dryer section 52 to dry the coating. The substrate 80 exits the fourth dryer section 52, where it is routed to the sixth transport roll section 56f, and then the seventh transport roll section 56g. The substrate 80 leaves the seventh transport roll section 56g and enters the second reel section 68b, where the substrate 80 contacts the king roll 72b and is wound to form the coated reel 76b.

FIG. 5 illustrates the coater 10 operating in a fourth operational configuration. In the fourth operational configuration, the coater 10 is configured to laminate two cellulose based substrates to form a laminate, and then apply a pigment based coating on at least one side of the resultant laminate. Accordingly, the coater 10 inline laminates and coats the two cellulose based substrates resulting in a coated laminate.

The first cellulose based substrate 80 is provided on the first reel 26. The first reel 26 is mounted onto the first unwind stand 14, where it unwinds the first substrate 80 and directs it to the first coating station 38. However, nothing is applied to the first substrate 80 at the first coating station 38. Instead, the first substrate 80 travels through the first coating station 38 and around the drive roll 39. It should be appreciated that the drive roll 39 rotates in a direction that is opposite the direction of rotation in the first and third operational configurations discussed above. This allows the drive roll 39 to direct the first substrate 80 to a nip assembly 104, instead of the first dryer section 40.

The second cellulose based substrate 92 is provided on the second reel 34. The second reel 34 is mounted onto the second unwind stand 18. The second unwind stand 18 unwinds the second substrate 92 and directs it to the first transport roll section 56a. The second substrate 92 exits the first transport roll section 56a and enters the second coating station 42. At the second coating station 42, an adhesive is applied to the second substrate 92. The adhesive is a water based adhesive. For example, the adhesive can be W3321CH adhesive sold by WISDOM ADHESIVES WORLDWIDE located in Elgin, Ill. However, in other embodiments, any adhesive suitable to bond the first and second substrates 80, 92 to form a laminate can be used. The adhesive is applied through the coating head of the second coating station 42 to a side of the second substrate 92 that will face the first substrate 80. After application of the adhesive, the second substrate 92 exits the second coating station 42 and travels to the nip assembly 104.

In alternative examples, the adhesive may not be a water-based adhesive (e.g., the adhesives may comprise solvents other than water or may be substantially free of solvent). Examples of these types of adhesives generally include, but are not limited to, solventborne adhesives, hot melt adhesives, acrylic adhesives, natural and/or synthetic rubber adhesives, silicone adhesives, thermal-setting adhesives, pressure-sensitive adhesives, or any combination thereof. Specific examples of these adhesives may include, but are not limited to rubber cements, latex emulsions, polyvinyl acetate, epoxies, acrylics, etc.

At the nip assembly, the first substrate 80 is laminated to the second substrate 92. More specifically, the first and second substrates 80, 92 enter a nip defined by a first drive roll 108 and a second drive roll 112. The second drive roll 112 is configured to slide into and out of engagement with the first drive roll 108. For example, in the configurations illustrated in FIGS. 1-4, the second drive roll 112 is positioned out of engagement with the first drive roll 108. For the configuration illustrated in FIG. 5, the second drive roll 112 slides into engagement with the first drive roll 108 along a carriage assembly (not shown) to define the nip. The carriage assembly provides sufficient pressure at the nip to press the first and second substrates 80, 92 together. The first substrate 80 contacts the surface of the second substrate 92 having adhesive, forming a cellulose based laminate 116. Stated another way, the laminate 116 is defined by layers of the first and second cellulose based substrates 80, 92. In the illustrated embodiment, the first substrate 80 can be a bleached cellulose based substrate, and the second substrate 92 can be an unbleached (or Kraft) cellulose based substrate. Accordingly, the first and second substrates 80, 92 can be different cellulose based substrates. In other embodiments of the coater 10, the first substrate 80 can be the unbleached (or Kraft) cellulose based substrate, while the second substrate 92 can be the bleached cellulose based substrate. In yet other embodiments, the first and second substrates 80, 92 can both be bleached cellulose based substrates, or can both be unbleached cellulose based substrates. In yet other embodiments, the first and second substrates 80, 92 can both be substantially similar materials, or different materials. In yet other embodiments the first and second substrates 80, 92 can be any suitable cellulose based substrate.

The cellulose based laminate 116 exits the nip assembly 104 and travels to the second dryer section 44 to dry the adhesive. The laminate 116 exits the second dryer section 44, where it is routed to the second transport roll section 56b, and then the fourth transport roll section 56d. The laminate 116 exits the fourth transport roll section 56d and enters the third coating station 46 with the first substrate 80 (i.e., the bleached cellulose based substrate) facing the coater head. The third coating station 46 applies a first layer of pigment based coating to the first substrate 80 side of the laminate 116. The laminate 116 exits the third coating station 46 and travels to the third dryer section 48 to dry the coating. The laminate 116 exits the third dryer section 48, where it is routed to the fifth transport roll section 56e. The laminate 116 exits the fifth transport roll section 56e and travels to the fourth coating station 50. At the fourth coating station 50, water (or a water like compound) is applied to the second substrate 92 side of the laminate 116. The application of water is to improve curl tendencies (i.e., to avoid excessive curl) of the laminate 116. The laminate 116 exits the fourth coating station 50 and travels to the fourth dryer section 52 to dry the applied water. The laminate 116 exits the fourth dryer section 52, where it is routed to the sixth transport roll section 56f, and then the seventh transport roll section 56g. The laminate 116 leaves the seventh transport roll section 56g and enters the second reel section 68b, where the laminate 116 contacts the king roll 72b and is wound to form the laminate reel 76b.

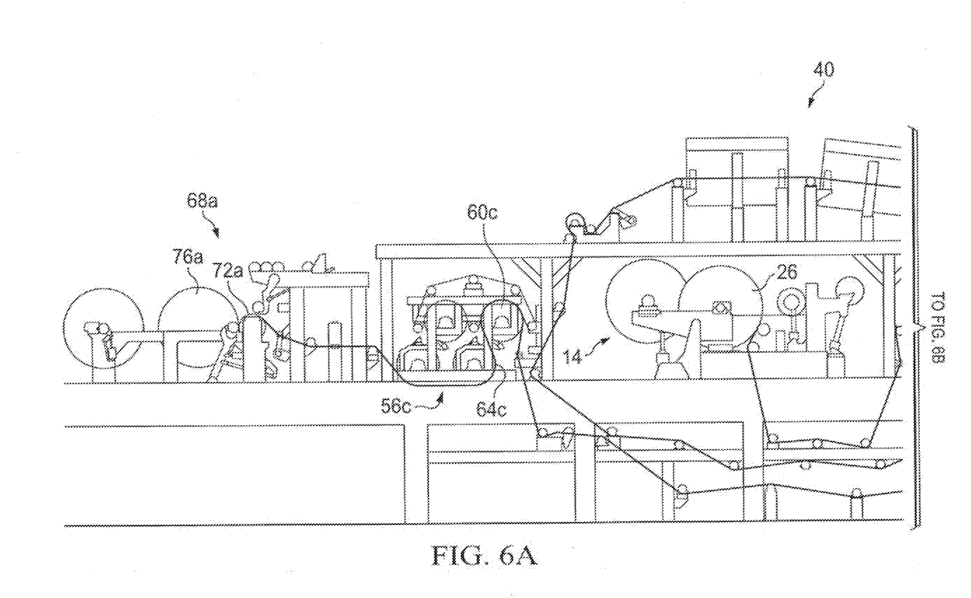

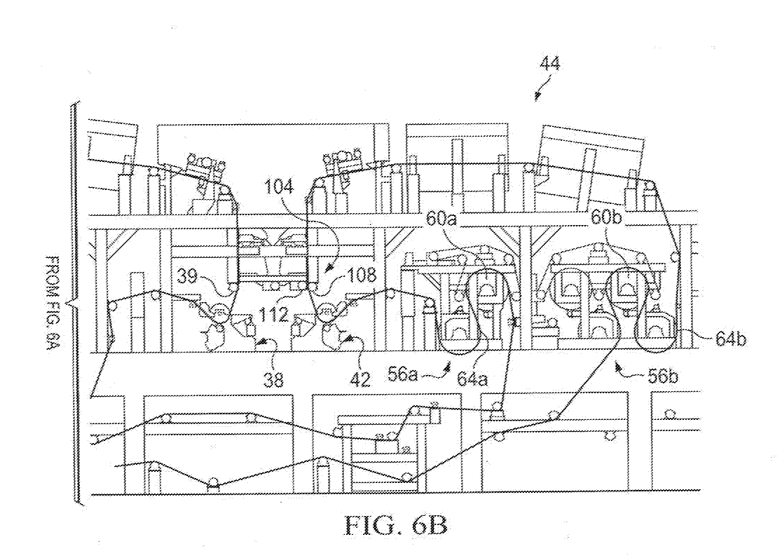

FIGS. 6A-6B are consecutive side views of the coater illustrated by the schematic in FIG. 2. To orient the consecutive views, element A of FIG. 6A and element A of FIG. 6B are a common element.

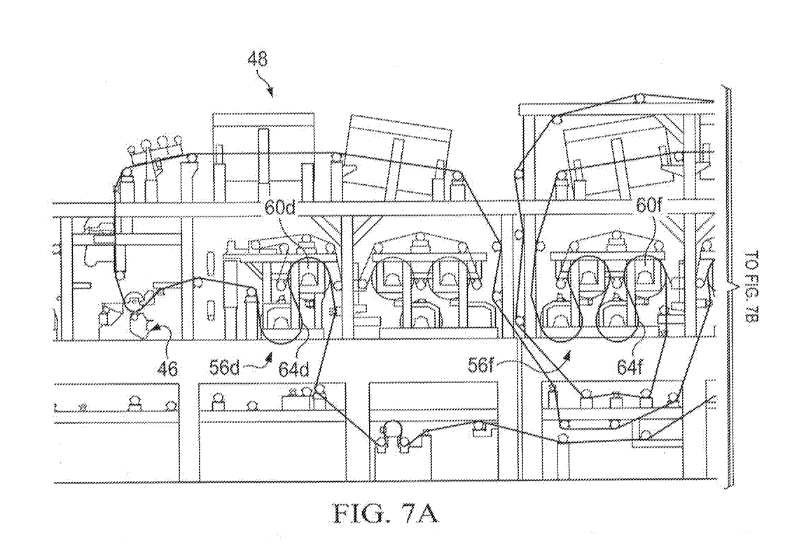

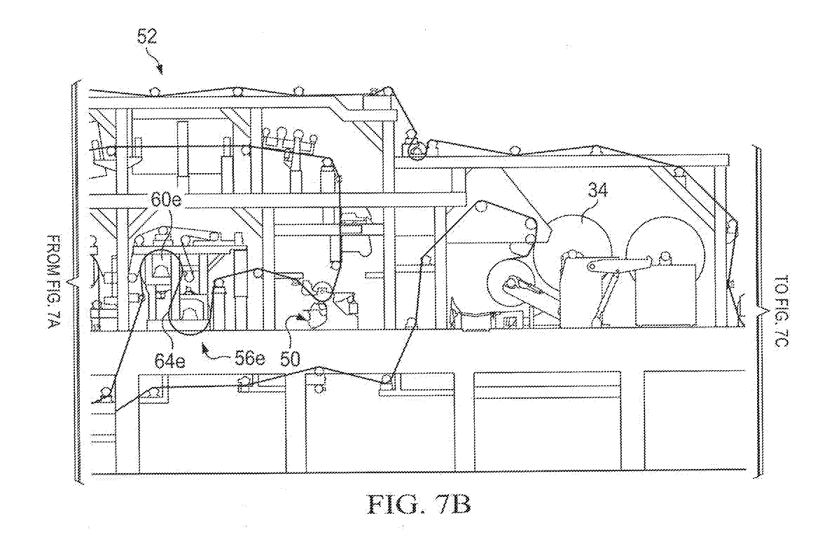

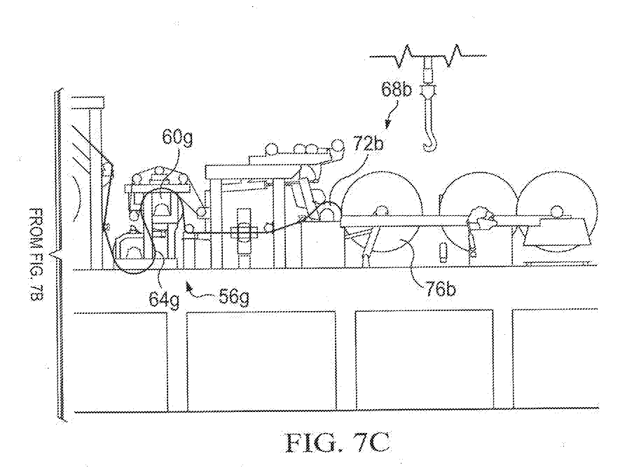

FIGS. 7A-7C are consecutive side views of the coater illustrated by the schematic in FIG. 3. To orient the consecutive views, element A of FIG. 7A and element A of FIG. 7B are a common element. In addition, element B of FIG. 7B and element B of FIG. 7C are a common element.

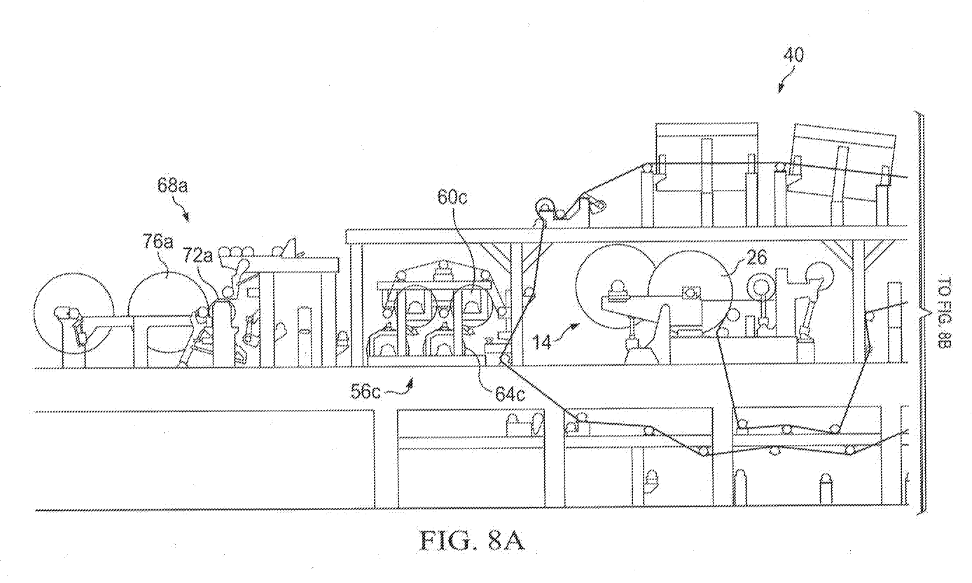

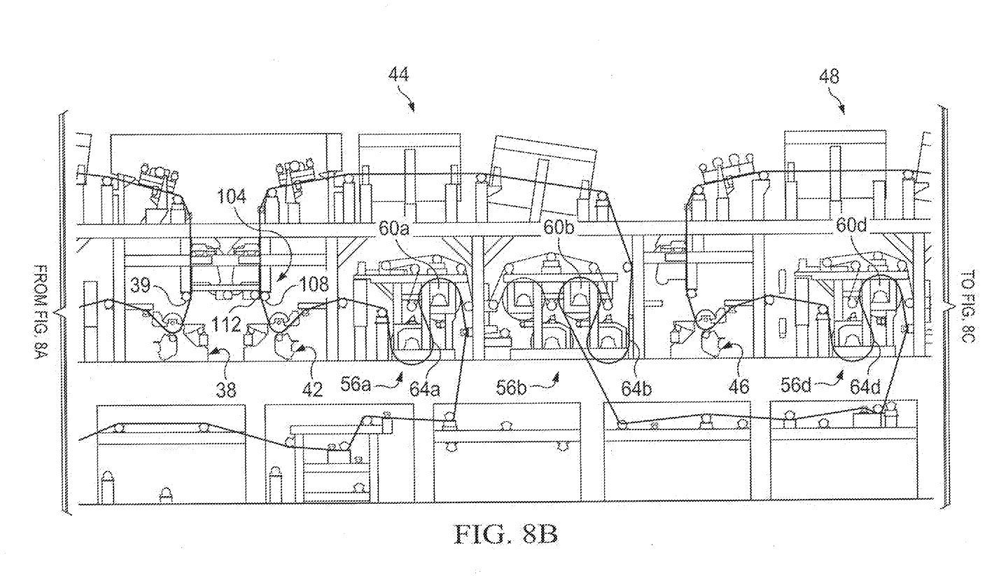

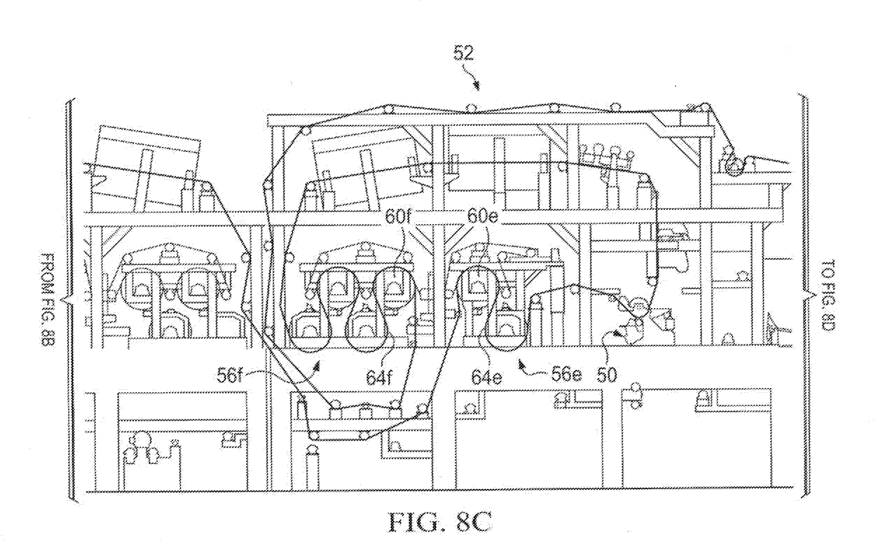

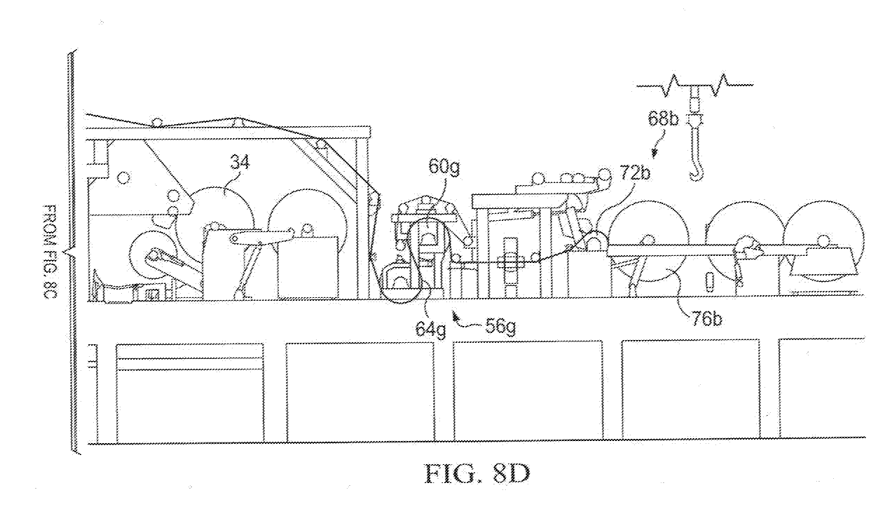

FIGS. 8A-8D are consecutive side views of the coater illustrated by the schematic in FIG. 4. To orient the consecutive views, element A of FIG. 8A and element A of FIG. 8B are a common element. In addition, element B of FIG. 8B and element B of FIG. 8C are a common element. Finally, element C of FIG. 8C and element C of FIG. 8D are a common element.

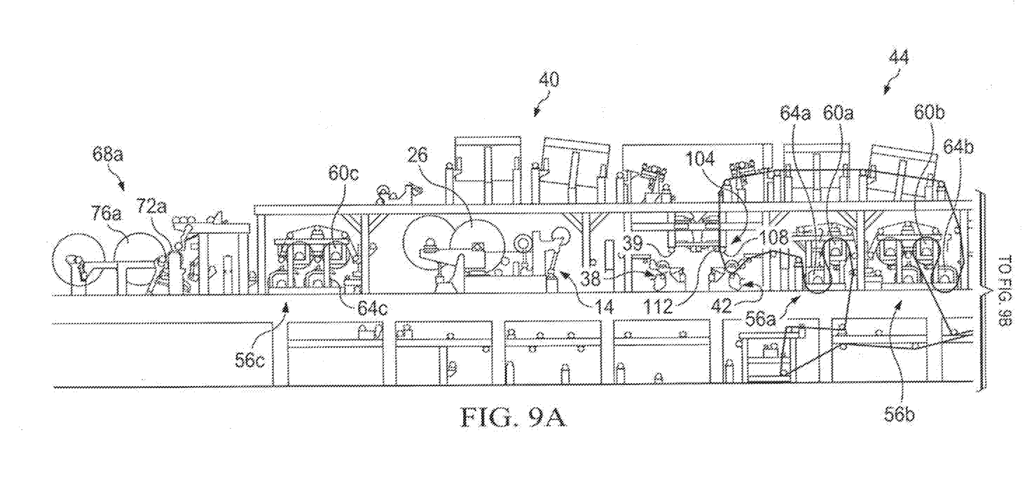

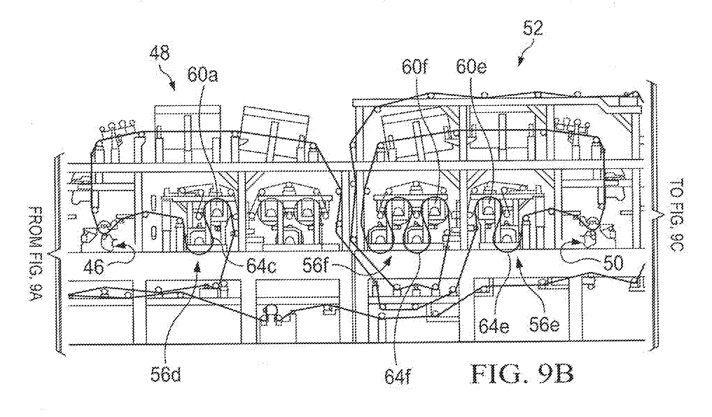

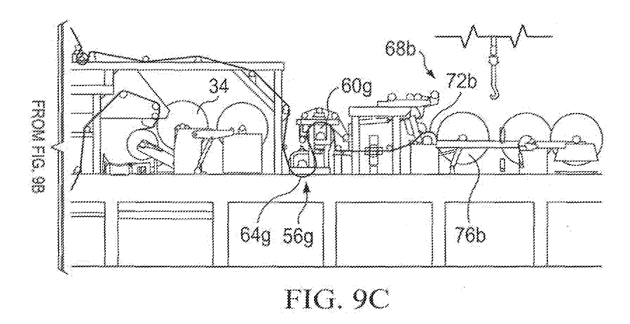

FIGS. 9A-9C are consecutive side views of the coater illustrated by the schematic in FIG. 5. To orient the consecutive views, element A of FIG. 9A and element A of FIG. 9B are a common element. In addition, element B of FIG. 9B and element B of FIG. 9C are a common element.

The coater 10 disclosed herein provides advantages over known systems for laminating two cellulose based substrates, and further coating the resultant laminate. The coater 10 laminates the two substrates in a dry-web form by an adhesive. The adhesive is applied by a coating head of the coater, which advantageously eliminates the need for a specialty paper machine to manufacture a cellulose based laminate. Stated another way, any suitable paper machine can supply the first and second cellulose based substrates 80, 92 to the coater 10 to form the cellulose based laminate 116. Further, using a water based adhesive provides effective adhesion of the substrate layers, while reducing cleanup time of the coating station when transferring between a laminating operational configuration and a coating operation configuration. In addition, the coater 10 advantageously laminates and coats the laminate inline, eliminating the need for any additional specialty equipment (e.g., a laminator, etc.) to manufacture a cellulose based laminate. Further, the coater 10 can readily switch between at least a first, coating operation configuration, and a second, laminating operational configuration. This allows the coater 10 to apply a pigment based coating to a cellulose based substrate, or to laminate a plurality of cellulose based substrates and subsequently apply a pigment based coating to the laminate. This advantageously increases usage of the coater 10, which reduces undesirable coater 10 downtime. In addition, the coater 10 can advantageously produce a wider variety of cellulose based products (e.g., coated free sheet, coated laminate, etc.), diversifying products that can be produced at a paper mill. These and other advantages may be realized from one or more embodiments of the autonomous coater 10 disclosed herein.

1. A coater configured to manufacture a laminated coated product comprising:
a first coating station configured to apply an adhesive to a side of a first cellulose based substrate;
a first nip assembly configured to press the adhesive coated side of the first cellulose based substrate to a second cellulose based substrate to form a laminate;
a first dryer section;
a second coating station configured to apply a coating to the second cellulose based substrate side of the laminate;
a second dryer section configured to dry the coating on the laminate; and
a reel section configured to wind a reel of the laminate.

2. The coater of claim 1, wherein the first cellulose based substrate is an unbleached cellulose based substrate, and the second cellulose based substrate is a bleached cellulose based substrate.

3. The coater of claim 1, wherein the first cellulose based substrate is an unbleached cellulose based substrate, and the second cellulose based substrate is an unbleached cellulose based substrate.

4. The coater of claim 1, wherein the first cellulose based substrate is a bleached cellulose based substrate, and the second cellulose based substrate is a bleached cellulose based substrate.

5. The coater of claim 1, wherein the first cellulose based substrate is a bleached cellulose based substrate, and the second cellulose based substrate is an unbleached cellulose based substrate.

6. The coater of claim 1, wherein the first cellulose based substrate and the second cellulose based substrate are each formed of the same material.

7. The coater of claim 1, wherein the first cellulose based substrate and the second cellulose based substrate are each formed of different materials.

8. The coater of claim 1, wherein the adhesive is a water based adhesive.

9. The coater of claim 1, wherein the adhesive is not a water based adhesive.

10. The coater of claim 1, further comprising:
a third coating station configured to apply water to a surface of the laminate; and
a third dryer section configured to dry the applied water on the laminate.

11. The coater of claim 1, further comprising a first unwind stand configured to unwind a reel of the first cellulose based substrate.

12. The coater of claim 11, further comprising a second unwind stand configured to unwind a reel of the second cellulose based substrate.

13. The coater of claim 1, wherein the first dryer section and the second dryer section comprise a dryer selected from the group consisting of steam dryers, gas dryers, air cap dryers, flotation dryers, infrared dryers, air impingement dryers, gas or steam heated cylindrical dryers, ultraviolet dryers, and any combination thereof.

14. The coater of claim 1, wherein the coating comprises a coating selected from the group consisting of aqueous-based coatings, pigmented coatings, calcium carbonate coatings, clay coatings, titanium dioxide coatings, latex coatings, starch coatings, polyvinyl acetate coatings, polyvinyl alcohol coatings, carboxymethyl cellulose coatings, hydroxymethyl cellulose coatings, epoxy coatings, coatings that are partially or totally impermeable to water, oil, or grease; coatings that may be printed on; and any combinations thereof.

15. A coater comprising:
a first coating station;
a nip assembly;
a second coating station;
a third coating station;
a first unwind stand; and
a second unwind stand, wherein
in a first configuration, the coater is configured such that a first cellulose based substrate travels from the first unwind stand to the first coating station, from the first coating station to the second coating station, and from the second coating station to the first reel section, wherein a first coating is applied to a first side of the first cellulose based substrate at the first coating station, and a second coating is applied to a second side of the first cellulose based substrate at the second coating station, and
in a second configuration, the coater is configured such that the first cellulose based substrate travels from the first unwind stand to the nip assembly, a second cellulose based substrate travels from the second unwind stand to either the first coating station or the second coating station and then to the nip assembly, wherein an adhesive is applied to a side of the second cellulose based substrate at either the first coating station or the second coating station, the first cellulose based substrate contacts the adhesive side of the second cellulose based substrate at the nip assembly to form a laminate, the laminate travels to the third coating station, wherein a coating is applied to the first cellulose based substrate side of the laminate to form a coated laminate.

16. The coater of claim 15, further comprising:
a fourth coating station, wherein in the second configuration, the coated laminate travels to the fourth coating station, wherein a coating is applied to the second cellulose based substrate side of the coated laminate.

17. A method for laminating substrates, the method comprising:
providing a coater comprising:
a first coating station;
a nip assembly;
a second coating station;
a third coating station;
a first unwind stand; and
a second unwind stand, wherein
unwinding a first cellulose based substrate from the first unwind stand;
directing the first cellulose based substrate to the nip assembly;
unwinding an second cellulose based substrate from the second unwind stand;
directing the second cellulose based substrate to either the first coating station or the second coating station;
directing the second cellulose based substrate to the nip assembly;
applying an adhesive to a side of the second cellulose based substrate at either the first coating station or the second coating station;
contacting the adhesive side of the second cellulose based substrate with the first cellulose based substrate at the nip assembly to form a laminate comprising a first cellulose based substrate side and a second cellulose based substrate side;
directing the laminate to the third coating station;
applying a coating to the first cellulose based substrate side of the laminate to form a coated laminate.

18. The method of claim 17, further comprising directing the coated laminate to a fourth coating station and applying a coating to the second cellulose based substrate side of the coated laminate.

19. The method of claim 17, further comprising winding the coated laminate with a reel section.

20. The method of claim 17, wherein the coating comprises a coating selected from the group consisting of aqueous-based coatings, pigmented coatings, calcium carbonate coatings, clay coatings, titanium dioxide coatings, latex coatings, starch coatings, polyvinyl acetate coatings, polyvinyl alcohol coatings, carboxymethyl cellulose coatings, hydroxymethyl cellulose coatings, epoxy coatings, coatings are partially or totally impermeable to water, oil, or grease; coatings that may be printed on; and any combinations thereof.
